(19) United States
(12) Patent Application Publication
(10) Pub. No.: US 2015/0283622 A1
(43) Pub. Date: Oct. 8, 2015

(54) TOOL MOUNTING APPARATUS

(71) Applicant: Ron BABCOCK, Odessa (CA)

(72) Inventor: Ron BABCOCK, Odessa (CA)

(21) Appl. No.: 14/248,286

(22) Filed: Apr. 8, 2014

(51) Int. Cl. B23B 45/00; B25H 1/00

(52) U.S. Cl. CPC B23B 45/008; B25H 1/0064; B25H 1/0078; B23B 2260/096; B23B 2270/34

(57) ABSTRACT

A tool mounting apparatus for a leverage force to a tool, the apparatus comprising: a frame; a frame support for supporting said frame to a workpiece acted on by said tool; a lever pivotally connected to said frame; an attachment mechanism for securing said tool to said lever; and whereby a force is applied to said lever to cause said to advance towards said workpiece and act on said workpiece.

### BACKGROUND OF THE INVENTION

1. Field of the Invention

The present invention relates to drilling.

2. Description of the Related Art

Using a hand drill to make a bore in a metallic workpiece can be challenging. The initial penetration of the drill bit into the workpiece is often difficult, time-consuming and frustrating to an average user. Typically, the drill bit will dance around, or slide on the surface of the workpiece and the user must exert a considerable force to the drill body in order to stop the drill bit from dancing around. This process is especially exacerbated when the workpiece is a cylindrical pipe. One solution to this problem has been to first create a pilot hole, or create an indentation with a center-punch and hammer at the point to be drilled, and then place the point of the bit in the indentation and start drilling. A user is forced to lean in on the drill to apply pressure on the drill bit, however, for pipes in excess of ⅜ inches, drilling a single hole may be especially time-consuming and exhausting for a user, as the user may only apply so much force on the drill before fatigue sets in, thereby lengthening the completion time for the bore. In addition, there is an additional difficulty in holding the drill steadily and rigidly on a pipe to be bored, which may result in undesirable bores, the drill bit jamming within the bore, or worse-still breaking within the bore. It is therefore apparent that using a hand drill for such an operation has numerous drawbacks, and is not ideal for applications or industries in which a plurality bores are desired as part of the production.

It is an object of the present invention to mitigate or obviate at least one of the above-mentioned disadvantages.

### SUMMARY OF THE INVENTION

In one of its aspects, there is provided a tool mounting apparatus for a leverage force to a tool, the apparatus comprising:
a frame;
a frame support for supporting said frame to a workpiece acted on by said tool;
a lever pivotally connected to said frame;
an attachment mechanism for securing said tool to said lever;
whereby a force is applied to said lever to cause said to advance towards said workpiece and act on said workpiece; and
whereby said lever provides a mechanical advantage when said force is applied.

In another of its aspects, there is provided a method for applying a leverage force to a tool, the method comprising the steps of:
selecting a desired location for acting on a workpiece;
placing a tool mounting apparatus on said workpiece; said apparatus comprising:
   a frame;
   a frame support for supporting said frame to said workpiece
   a lever pivotally connected to said frame;
   an attachment mechanism for securing said tool to said lever;
applying a force to said lever to cause said tool to advance towards said workpiece and act on said workpiece; and
   whereby said lever provides a mechanical advantage when said force is applied.

In another of its aspects, there is provided a method for drilling a hole through a workpiece in a fast and efficient manner. The method is especially useful for drilling horizontal holes through a vertically disposed workpiece, such as a cylindrical pipe, with substantially thick walls. Advantageously, holes may be drilled in the workpiece with minimal effort, which results in decreased fatigue on the user, and less frustration, thereby increasing production.

### BRIEF DESCRIPTION OF THE DRAWINGS

Several preferred embodiments of the present invention will now be described, by way of example only, with reference to the appended drawings in which:

FIG. 1 shows a schematic diagram of a tool mounting apparatus;

FIG. 2 shows a drill resting within a frame of the tool mounting apparatus of FIG. 1;

FIG. 3 shows a drill guide and attachment means for a drill;

FIG. 4 shows a drill guide with a depth gauge, in another embodiment;

FIG. 5 shows a schematic diagram of a tool mounting apparatus, in another embodiment; and

FIG. 6 shows a schematic diagram of a tool mounting apparatus, in yet another embodiment.

### DETAILED DESCRIPTION OF EXEMPLARY EMBODIMENTS

The detailed description of exemplary embodiments of the invention herein makes reference to the accompanying block diagrams and schematic diagrams, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

Moreover, it should be appreciated that the particular implementations shown and described herein are illustrative of the invention and its best mode and are not intended to otherwise limit the scope of the present invention in any way.

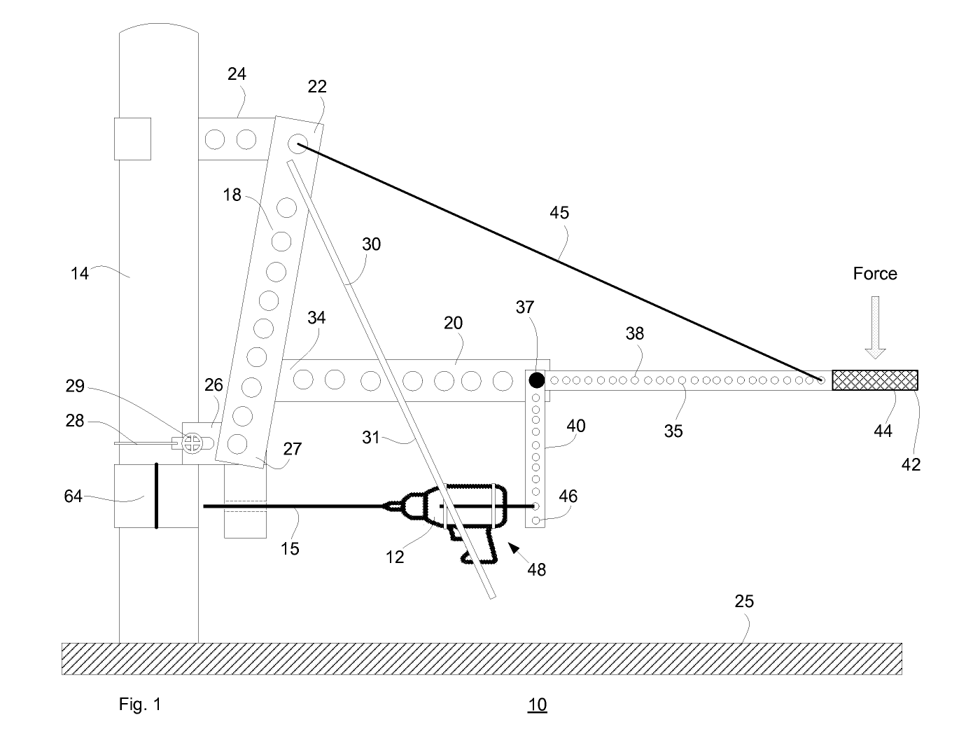

FIG. 1 shows a tool mounting apparatus 10 having a drill 12 mounted thereon, in an exemplary embodiment. The tool mounting apparatus 10 is secured to a workpiece 14 that is to be bored by a drill bit 15. In more detail, the mounting apparatus 10 comprises a frame 16 having a vertical arm 18 and a horizontal arm 20 joined together. The vertical arm 18 and horizontal arm 20 are substantially perpendicular to each other.

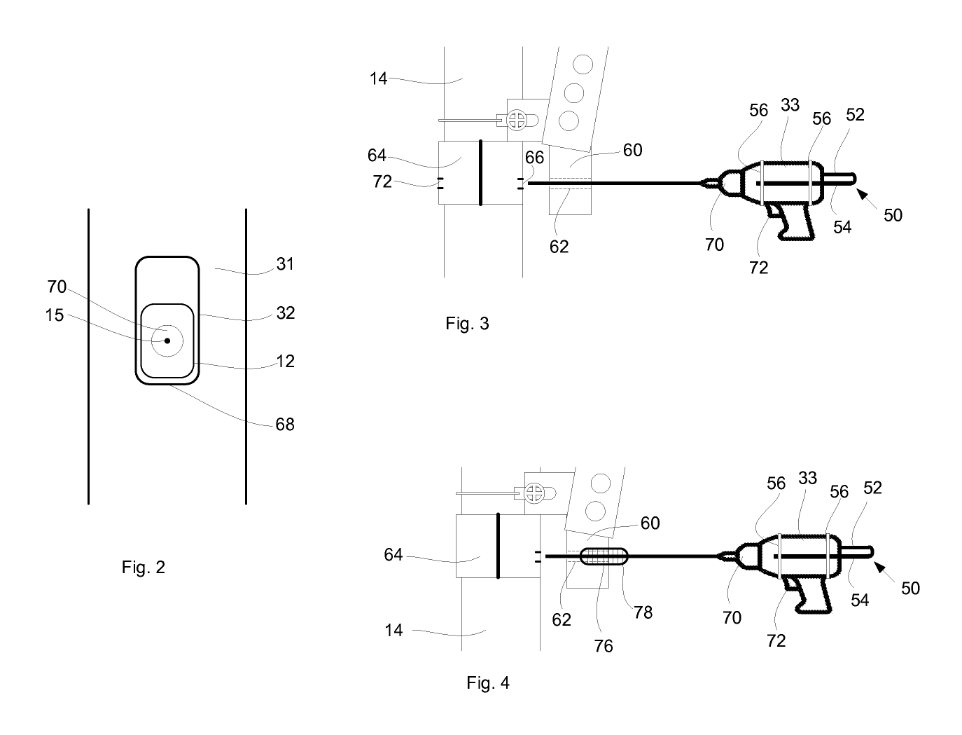

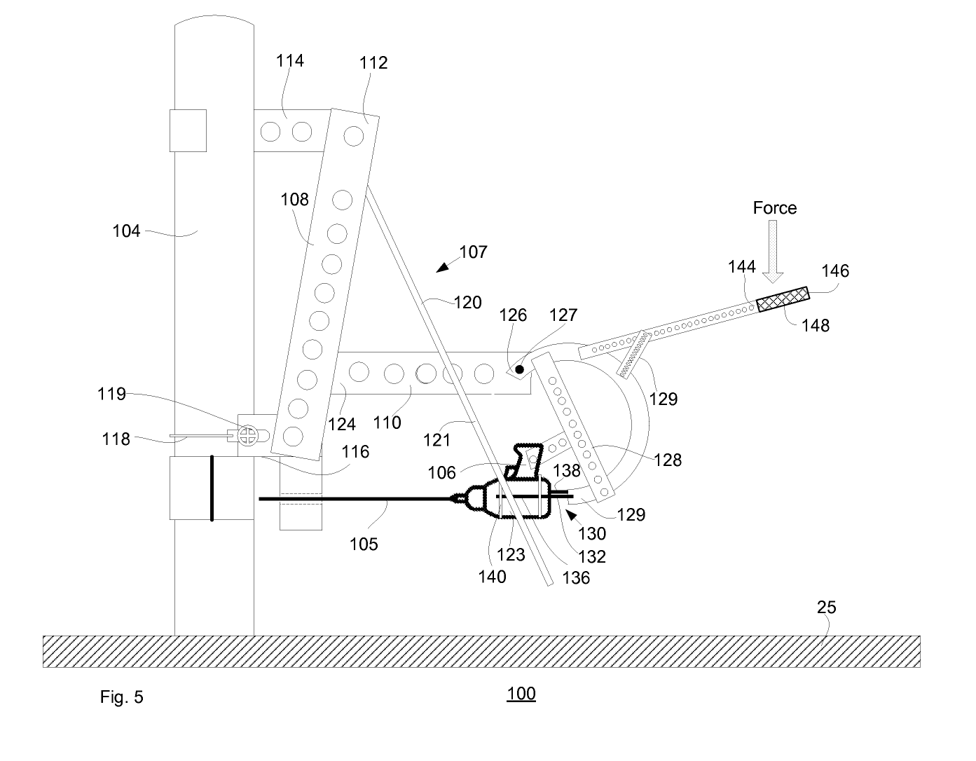

An upper end 22 of the vertical arm 18 comprises an upper support 24 for releasably engaging the workpiece 14 above a ground plane 25, and a lower support 26 proximate a lower end 27 for releasably engaging the workpiece 14, in order to rigidly secure the mounting apparatus 10 to the workpiece 14. A chain-link 28 is attached proximate the lower end 27 of the vertical arm 18 and wraps around the workpiece 14 and secured via a speedy nut 29 (and bolt). An elongate plate 30 extends from proximate the upper end 22 of the vertical arm 18 and intersects about the middle of the horizontal arm 20 at an angle, and extends beyond the horizontal arm 20. The elongate plate 30 is rigidly joined to the vertical arm 18 and the horizontal arm 20 of the frame 16, via welding or other joinder mechanisms. A lower portion 31 of the plate 30 comprises an aperture 32 which receives a drill body 33 to provide support for the drill 12, as shown in FIG. 2.

One end 34 of the horizontal arm 20 is securedly attached proximate to the lower end 27 of the vertical arm 18. An L-shaped lever 35 is pivotally attached proximate to another end 36 of the horizontal arm 20 at a pivot point 37. The lever 35 comprises an elongate actuating first leg 38 and a second leg 40, substantially perpendicular to the elongate actuating first leg 38. The elongate actuating first leg 38 includes a free-end 42 having a manual grip portion 44 formed thereon, preferably a slip-on elastomeric grip engageable by a user's hand to apply a force thereto. A resilient biasing member 45 extends between upper end 22 of the vertical arm 18 and adjacent to free-end 42. The resilient biasing member 45 allows the lever 35 to return to a rest position after the force is removed from manual grip portion 44.

The second leg 40 of the lever 35 is substantially vertical to the ground plane 25, and extends downwardly from the pivot point 37 towards the ground plane 25, and terminates at free end 46. The second leg 40 includes an attachment mechanism 48 for securing the drill 12 thereto. The attachment mechanism 48 is hingedly attached proximate to free end 46 of the second leg 40, and comprises a U-shaped rod 50 received by a hole 51. The U-shaped rod 50 is formed of a pair of interconnected tines 52, 54 which abut opposing sides of a drill body 33. A clamp 56, such as a hose clamp, placed over the tines 52, 54 and around the body portion 33 of the drill 12 is tightened to securely fasten the drill 12 to the apparatus 10. For example, the hose clamp 56 comprises a worm gear and a tightening band, such as a metal strip perforated to correspond with teeth of the worm gear. Other suitable attachment mechanism include any conventional device or devices used to secure one object to another, such as, for example, devices that wrap around the drill 12 such as, straps, lines or cables or other types of fasteners. Accordingly, the attachment mechanism 48 restricts any axial motion of the drill body 33 within the aperture 32 and translates the force applied on the manual grip portion 42 of the elongate actuating first leg 38 into a longitudinal force to the drill 12.

As can be seen in FIG. 3, below the lower support 26 is a drill bit guide 60 which sets out a path for the drill bit 15 towards the desired boring location on the workpiece 14. The drill bit guide 60 comprises an aperture 62 formed within the vertical arm 18, and proximate the lower end 37 thereof. A bracket 64 releasably secured to the workpiece 14 comprises a complementary aperture 66 which exposes and pinpoints the desired boring location on the workpiece 14. Apertures 62, 66 may be dimensioned such that drill bits 15 with a variety of gauges may be received therethrough and can rotate substantially freely therein, when apertures 62, 66 are coaxially aligned. As an example, drill bit 15 may be 7/16 inches and apertures 62, 66 are dimensioned accordingly to accommodate such a drill bit 15. As drill bit 15 may brush against the interior walls of apertures 62, 66, the interior walls of apertures 62, 66 are carburized to mitigate excessive, breakage or premature failure of drill bit 15 during operation. In one example, the drill bit guide 60 may have an aperture 62 dimensioned to receive drill bits 15 having a large gauge, and a plurality of discs with apertures dimensioned to receive drill bits 15 having a smaller gauge, whereby the plurality of discs may be removably secured over the aperture 62 to accommodate the smaller gauge drill bits 15. Correspondingly, the bracket 64 may include similar features. In another example, drill bit guide 60 is removably secured to the vertical arm 18, and proximate the lower end 37 thereof. Accordingly, a plurality of drill bit guides 60 having apertures 62 with different sizes are provided to accommodate a variety of drill bit 15 gauges.

As stated above, the upper support 24 and lower support 26 allow the mounting apparatus 10 to be rigidly secured to the workpiece 14. The upper support 24 and lower support 26 are adapted to suit the contour of the workpiece 14 to be drilled, and therefore may include any configuration that interfaces with the workpiece 14. As shown in FIG. 1, given that the workpiece 14 is a cylindrical pipe, the upper support 24 and lower support 26 comprise a curved profile that complements the curvilinear nature of the cylindrical pipe 14. The upper support 24 is so dimensioned such that it substantially wraps around the workpiece 14 in a penannular fashion, while the lower support 26 is C-shaped and abuts the portion of the workpiece 14 facing the frame 16.

In another exemplary embodiment, when the workpiece 14 is relatively planar, then the upper support 24 and lower support 26 are relatively planar.

An exemplary method of operation will now be described with reference to FIGS. 1 to 3. The method comprises the steps of, selecting a desired location for drilling a bore and placing the bracket 64 on the workpiece 14 such that the complementary aperture 66 on the bracket 64 lies over the desired location. Next, the the frame 16 is oriented such that the upper support 24 may be placed on the workpiece 14 and substantially wraps around the workpiece 14 in a penannular fashion; and abutting the lower support 26 against the workpiece 14. The weight of the apparatus 10 is thus held in place by the upper support 24 corralling the back of the workpiece 14, while the lower support 26 corals the front of the workpiece 14. In addition, the lower support 26 is rested on the bracket 64, and thus also bears the weight of the apparatus 10 and helps to maintain the position of the apparatus 10 on the workpiece 14. Next, the chain-link 28 is wrapped around the workpiece 14 and the free end is attached to the frame 16, and tightened via a speedy nut 29 (and bolt) to loosely secure the frame 16 to the workpiece 14. The frame 16 can now be translated along the workpiece 14 and is positioned in an operating position such that the two apertures 62, 66 are coaxial. A chain link 28 is tightened to rigidly fasten the apparatus 10 to the workpiece 14. Next, the drill 12 is placed in a rest position in the aperture 32 and rests on seat 68. An appropriate drill bit 15 is secured in a drill chuck 70, and the drill 12 is urged towards the workpiece 14, such that the drill bit 15 is inserted into the drill bit guide aperture 62 and the aperture 66 in the bracket 64. Next the drill 12 is powered on to cause rotational motion of the drill bit 15. Preferably, a drill trigger switch 72 is permanently actuated and a separate on/off switch is electrically coupled thereto to prevent a user from holding down the trigger switch 72, as is typical with a trigger switch in a typical boring operation. Accordingly, a user is not required to persistently hold down the trigger switch 72, and therefore will not suffer from fatigue during lengthy drilling sessions. Next, the user applies a force on the grip portion 44 of the elongate actuating first leg 38 of the lever 35, and the second leg 40 rotates in a clockwise manner about pivot point 37. Concurrently, the drill 12 is urged to move longitudinally through the aperture 32 of the diagonal plate 31 and the rotating drill bit 15 contacts the workpiece at the desired boring location, thus placing the drill in an operation position for the boring operation. The drill bit 15 is steadily pushed firmly against the workpiece 14 and begins to advance into the workpiece 14. The force is steadily applied onto the elongate actuating first leg 38 until the desired bore has been completed. Once completed the drill 12 may be turned off and a force in an anticlockwise fashion is applied to the elongate actuating first leg 38, which urges the drill 12 back through the aperture 32 and the drill bit 15 is backed out of the newly created bore, and through the apertures 62 and 66. With the force removed from the elongate actuating first leg 38, the drill 12 in now placed back in the rest position.

The bracket 64 may be include two diametrically opposed apertures 66, 72 such that after completion of the first bore through aperture 66 of bracket 64, the apparatus 10 is swung around to make the second bore. This bracket 64 feature is useful when opposing bores are desired, or in instances where the drill bit 15 is not long enough to drill from one side to the opposite side of the workpiece 14, or the drill bit 15 is likely to overheat or break. Accordingly, the first and second bores may form one continuous straight hole through the workpiece 14, or the bores are made to a predetermined depth into the workpiece 14.

Upon application of a downward force, the elongate actuating first leg 38 rotates about the pivot point 37, and a mechanical advantage is obtained in applying a force to the hand drill 12. While the mechanical advantage is related to the length of the elongate actuating first leg 38, in one exemplary embodiment the mechanical advantage is approximately 8 times the actual downward force applied to the elongate actuating first leg 38. Therefore, the benefit of the mechanical advantage facilitates continuous operation of the apparatus 10 by a user before fatigue sets in. In one example, a half-inch hand drill 12 is used to make a bore in a 4 inch SCH 80 pipe 14 and takes about 30 seconds to plunge through the example of side of pipe 14. As per the American National Standard Institute (ANSI) specifications, a 4 inch Schedule 80 (SCH 80) welded and seamless steel pipe has an outside diameter of 4.5 inches, a wall thickness of 0.337 inches. In one exemplary operation, the time to mount the press on the 4 inch SCH 80 pipe 14 and bracket 64 and tighten the chain link 28 and speedy nut 29 is approximately 30 seconds, drill one wall of the 4 inch SCH 80 pipe 14 is approximately 30 seconds, the time to remove the apparatus and reinstall on the opposite side of the 4 inch SCH 80 pipe 14 is approximately 30 seconds, and the approximate time to drill the opposite side of the 4 inch SCH 80 pipe 14 is 30 seconds. Therefore, the total boring operation takes approximately 120 seconds. After the two bores have been completed, the amount of time to remove the apparatus and reinstall the apparatus on the next 4 inch SCH 80 pipe 14 and bracket 64 is approximately 30 seconds. In a typical operation, a user using apparatus 10 can make two bores in 30 (thirty) 4 inch SCH 80 pipes 14 in one hour, or 60 bores/hour. In contrast, a user using the same half-inch hand drill 12 without the aid of the apparatus 10 and without the benefit of the mechanical advantage can only accomplish boring two bores in 24 (twenty four) 4 inch SCH 80 pipes in 40 hours (one work week), or only 1.2 bores/hour.

Once the boring operation on the workpiece 14 is complete, the apparatus 10 is removed in the opposite sequence from installation, and the drill 12 may remain attached to apparatus 10, if the apparatus 10 is to be placed on to another workpiece 14, or another location on the workpiece 14. As described above, the mounting and de-mounting of the apparatus 10 is relatively quick, and greatly improves efficiency.

In yet another embodiment, the bracket 64 may include a plurality of apertures 66 such that a plurality of bores in the workpiece 14 may be made in accordance to the configuration of the apertures 66 or as desired by the user or the application. For example, bores may be made using only a portion of the apertures 66.

In another embodiment, the apparatus 10 comprises markings for indicating the depth of bore or the length of the drill bit 15 in the workpiece 14.

In another embodiment, the apparatus 10 comprises a means for setting a desired depth in the workpiece 14, as shown in FIG. 4. For example, an adjustable stop 76 is placed on the guide 60, and is placed on a track 78 such that the adjustable stop 76 may be locked at any point on the track 78 to abut the chuck 70 as the drill 12 is urged towards the workpiece 14. As such, markings on the track 76 may be used to select the desired depth of the bore in workpiece 14.

In another embodiment, the lever 35 comprises a brace member 80 extending from the elongate actuating first leg 38 to the second leg 40.

In another embodiment, as shown in FIG. 4, tool mounting apparatus 100 is adapted to secure and operate drill 102 mounted upside-down thereon. The tool mounting apparatus 100 is secured to a workpiece 104 that is to be bored by a drill bit 105. This configuration is especially beneficial for drilling bores in workpieces 104 where the location of the bores is close to the ground plane 25, and therefore there is insufficient ground clearance for the drill 102, when oriented in an upright fashion with a drill hand-grip portion 106 pointing to the ground plane 25. Insufficient ground clearance may be caused by the terrain, or by build-up due to freezing rain, ice or snow.

In more detail, the mounting apparatus 100 comprises a frame 107 having a vertical arm 108 and a horizontal arm 110 joined together. The vertical arm 108 and horizontal arm 110 are substantially perpendicular to each other.

An upper end 112 of the vertical arm 108 comprises an upper support 114 for releasably engaging the workpiece and a lower support 116 proximate a lower end 117 for releasably engaging the workpiece 104, in order to rigidly secure the mounting apparatus 100 to the workpiece 104. A chain-link 118 is attached proximate the lower end 117 of the vertical arm 108 and wraps around the workpiece 104 and secured via a speedy nut 119 (and bolt). An elongate plate 120 extends from proximate the upper end 112 of the vertical arm 108 and intersects about the middle of the horizontal arm 110 at an angle, and extends beyond the horizontal arm 110. The elongate plate 120 is rigidly joined on to the vertical arm 108 and the horizontal arm 110 of the frame 107, via welding or other joinder mechanisms. A lower portion 121 of the plate 120 comprises an aperture 122 which receives a drill body 123 to provide support for the drill 102, as will be described in greater detail below. One end 124 of the horizontal arm 110 is securedly attached proximate to the lower end 117 of the vertical arm 108.

An C-shaped arm 125 is pivotally attached proximate to another end 126 of the horizontal arm 110 at a pivot point 127. The C-shaped arm 125 curves downwardly to the ground plane 25 from pivot point 127, and terminates at free end 126. A brace 128 is secured to C-shaped arm 125 adjacent to pivot point 127 and extends diagonally to near free end 129 of the C-shaped arm 125. An attachment mechanism 130 for securing the drill 102 is hingedly attached proximate free end 129 of the C-shaped arm 125, and comprises a U-shaped rod 132 received by a hole 134. The U-shaped rod 132 is formed of a pair of interconnected tines 136, 138 which abut opposing sides of a drill body 123. A clamp 140 such as a hose clamp, placed over the tines 136, 138 and around drill body portion 123 of the drill 102 is tightened to securely fasten the drill 102 to the apparatus 100. For example, the hose clamp 140 comprises a worm gear and a tightening band, such as a metal strip perforated to correspond with teeth of the worm gear. Other suitable attachment mechanism include any conventional device or devices used to secure one object to another, such as, for example, devices that wrap around the drill 102 such as, straps, lines or cables or other types of fasteners. For additional support, the drill hand grip portion 106 is also secured to the brace 128 via similar-type fasteners.

An elongate lever 142 is secured to the C-shaped arm 125, at one end 144, and free-end 146 includes a manual grip portion 148, preferably a slip-on elastomeric grip engageable by a user's hand to apply a force thereto. Accordingly, the attachment mechanism 130 restricts any axial motion of the drill body 123 within the aperture 122. The force applied on the manual grip portion 148 of the elongate lever 142 causes the C-shaped arm 125 to rotate about pivot point 127, and inflicts a longitudinal force to the drill 102 via the attachment mechanism 130. The drill body 123 is thus caused to move through aperture 122, thereby advancing the drill bit 105 towards the workpiece 104. The elongate lever 142 may also include a brace member 149 extending about midway of the elongate lever 142 to a lower portion of the C-shaped arm 125.

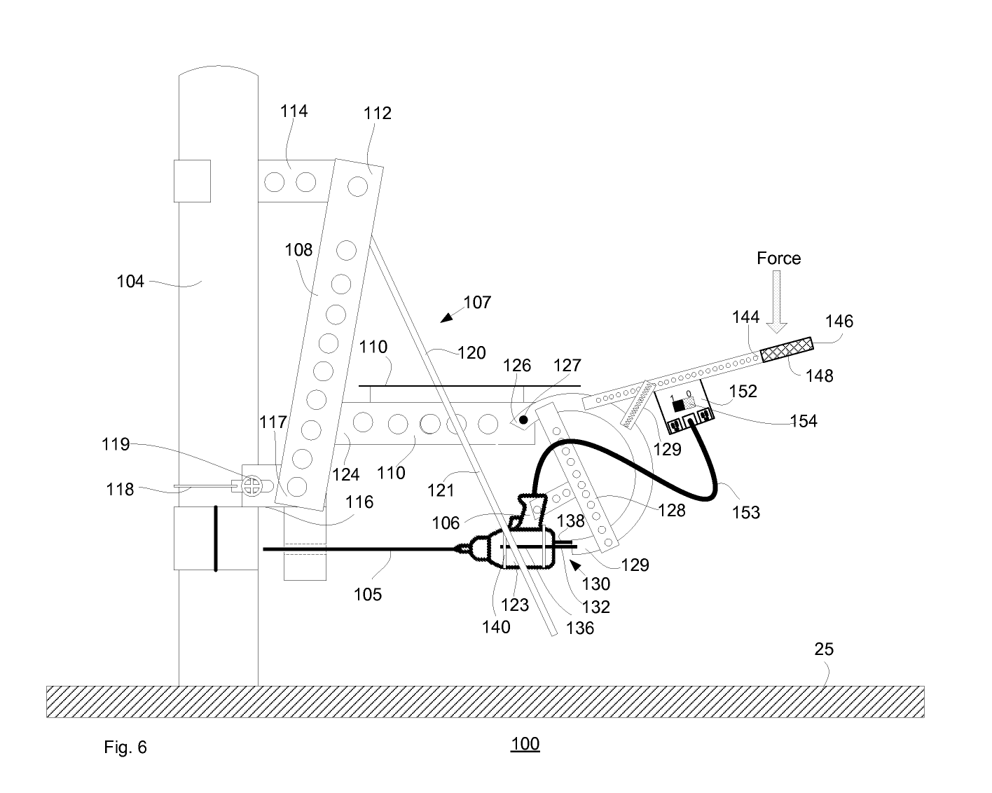

In another embodiment, the apparatus 100 may also include a roof 150 secured to the horizontal arm 110, and positioned above the drill 102, as shown in FIG. 6. The roof 150 helps to protect the drill 102 from overhead precipitation, such as rain, freezing rain, or snow. The apparatus 100 may include also a waterproof electrical box 152 secured to the elongate lever 142, to supply power to the drill 102 via cord 153. The electrical box 152 is electrically coupled to a power source and comprises a switch 154 and outlets 156. A light source (not shown) may be included to illuminate the work area, or may be directed towards the workpiece 104.

In another embodiment, the apparatus 10 may also include a similar roof and waterproof electrical box, as described above.

In one application, the apparatus 10 or 100 is useful for drilling bores in steel pipes 14 used as anchors for mounting solar panels.

In other embodiments, the power tool includes, but is not limited to, a driver, cutter, screwdriver, screw gun, hammer, hammer drill, rotary tool, saw; and these tools receive accessories or attachments such as blades, chisels, saws, saw blades; and so forth. Accordingly, the guides 60 include apertures corresponding to at least one characteristic of the accessory, such as length, width, depth, or diameter.

While preceding detailed description of exemplary embodiments of the invention makes reference to the tool being operated and oriented in a horizontal configuration, the tool may be operated in a vertical configuration, or at any angle depending on the work environment and location or orientation of the workpiece 14.

The preceding detailed description of exemplary embodiments of the invention makes reference to the accompanying drawings, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. For example, the steps recited in any of the method or process claims may be executed in any order and are not limited to the order presented. Thus, the preceding detailed description is presented for purposes of illustration only and not of limitation, and the scope of the invention is defined by the preceding description, and with respect to the attached claims.

The embodiments of the invention in which an exclusive property or privilege is claimed are defined as follows:

1. A tool mounting apparatus for a leverage force to a tool, the apparatus comprising:
a frame;
a frame support for supporting said frame to a workpiece acted on by said tool;
a lever pivotally connected to said frame;
an attachment mechanism for securing said tool to said lever;
whereby a force is applied to said lever to cause said to advance towards said workpiece and act on said workpiece; and
whereby said lever provides a mechanical advantage when said force is applied.

2. The tool mounting apparatus of claim 1, wherein said frame comprises a vertical arm and a horizontal arm substantially perpendicular to each other.

3. The tool mounting apparatus of claim 2, wherein said frame support comprises an upper support member adjacent to one end of said vertical arm and a lower support member adjacent to another end of said vertical arm.

4. The tool mounting apparatus of claim 3, wherein said frame support further comprises a fastener for securing said frame to said workpiece.

5. The tool mounting apparatus of claim 4, wherein said a fastener is one of a clamp, strap, line, cable, chain-link, and nut and bolt.

6. The tool mounting apparatus of claim 4, wherein said frame comprises a diagonal brace member having an upper end secured to said one end of said vertical member and secured to said horizontal arm about a midpoint of said diagonal brace member, with a portion of said diagonal brace member extending beyond said horizontal arm.

7. The tool mounting apparatus of claim 6, wherein said portion of said diagonal brace member comprises an aperture for receiving said tool and providing support and a travel channel for said tool when moving in response to said force.

8. The tool mounting apparatus of claim 7, wherein said aperture and said attachment mechanism positions said tool to act on said workpiece at a predetermined angle.

9. The tool mounting apparatus of claim 8, wherein said predetermined angle is 90 degrees.

10. The tool mounting apparatus of claim 9, wherein said lever comprises an elongate actuating first leg and a second leg substantially perpendicular to the elongate actuating first leg; said lever comprising a pivot point at an apex of said first leg and second leg;
wherein said force is applied to a free end of a length of said elongate actuating first leg; and
wherein said mechanical advantage is related to a length of said elongate actuating first leg.

11. The tool mounting apparatus of claim 10, wherein said mechanical advantage is approximately 8 times the applied force.

12. The tool mounting apparatus of claim 11, wherein said attachment mechanism is hingedly connected adjacent to a free end of said second leg, and wherein said force subject to said mechanical advantage is exerted onto said attachment mechanism to cause translation of said tool within said aperture.

13. The tool mounting apparatus of claim 12, wherein said tool is one of a power tool such as a hand drill, driver, cutter, screwdriver, screw gun, hammer, hammer drill, rotary tools, saws.

14. The tool mounting apparatus of claim 13, wherein said another end of said vertical arm comprises a guide for an accessory for said tool, such as drill bit, blade, chisel, saw, saw blade;
wherein said guide positions said accessory acts on a desired location on said workpiece.

15. The tool mounting apparatus of claim 14, further comprising a bracket mountable on said workpiece having a complementary guide for said accessory, and
wherein said complementary guide exposes said desired location on said workpiece.

16. The tool mounting apparatus of claim 15, wherein said guide is removably secured to said vertical arm, wherein said guide comprises an aperture and said complementary guide comprises a complementary aperture for receiving said accessory.

17. The tool mounting apparatus of claim 16, wherein said aperture of said guide corresponds to at least one characteristic of said accessory, wherein said at least one characteristic of said accessory includes one of a length, width, depth, and diameter.

18. A method for applying a leverage force to a tool, the method comprising the steps of:
selecting a desired location for acting on a workpiece;
placing a tool mounting apparatus on said workpiece; said apparatus comprising:
a frame;
a frame support for supporting said frame to said workpiece
a lever pivotally connected to said frame;
an attachment mechanism for securing said tool to said lever;
applying a force to said lever to cause said tool to advance towards said workpiece and act on said workpiece; and
wherein said lever provides a mechanical advantage when said force is applied.

19. The method of claim 18, wherein said frame comprises a vertical arm and a horizontal arm substantially perpendicular to each other; and
said frame support comprises an upper support member adjacent to one end of said vertical arm and a lower support member adjacent to another end of said vertical arm; said method comprising a further step of orienting said frame such that said upper support member and said lower support member engage said workpiece to secure said frame to said workpiece.

20. The method of claim 19, comprising a further step of mounting said tool to said frame and attaching an accessory thereto for interacting with said workpiece; and
powering on said tool to cause to cause motion of said accessory to perform a desired action on said workpiece.
